(19) United States
(12) Patent Application Publication
(10) Pub. No.: US 2026/0338292 A1
(43) Pub. Date: Oct. 29, 2026

(54) DIAPHRAGM VALVE

(71) Applicant: IHARA SCIENCE CORPORATION, Tokyo (JP)

(72) Inventor: Naoya KANAI, Tokyo (JP)

(73) Assignee: IHARA SCIENCE CORPORATION, Tokyo (JP)

(21) Appl. No.: 19/110,696

(22) PCT Filed: Apr. 11, 2023
(86) PCT No.: PCT/JP2023/014673

§ 371 Date: Mar. 11, 2025

(30) Foreign Application Priority Data
Sep. 12, 2022 (JP) 2022-144408

(51) Int. Cl. F16K 31/50; F16K 7/12

(52) U.S. Cl. CPC F16K 31/504; F16K 7/12

(57) ABSTRACT

A diaphragm valve includes a valve body including a first channel, a second channel, and a valve seat; a cover screwed to be attached to the valve body; a rotatable valve shaft screwed to the cover in a manner movable up and down; a stem connected to the valve shaft and provided with a threaded shaft coaxial with the valve shaft; a holder screwed to the threaded shaft and configured to come into contact with or separate from the valve seat to open or close the first channel and the second channel; and an annular diaphragm through which the threaded shaft penetrates. An outer peripheral portion of the diaphragm is mechanically clamped in a fixed manner between the valve body and the cover, and an inner peripheral portion of the diaphragm is mechanically clamped in a fixed manner between the stem and the holder.

### TECHNICAL FIELD

The present invention relates to a diaphragm valve configured to regulate a flow rate of a fluid flowing through a channel and to perform an opening and closing operation.

### BACKGROUND ART

Known diaphragm valves include a metal diaphragm valve that includes a thrust button configured to move up and down via a valve shaft when a handle is rotated; and a metal diaphragm (diaphragm) disposed between the thrust button and a valve seat provided for a valve body (see Patent Literature 1). In the diaphragm, its periphery is held by the valve body in a fluid-tight manner and its center portion bulges upward (i.e. toward the thrust button).

This metal diaphragm valve is used in semiconductor production equipment and the like. In the metal diaphragm valve, a diaphragm is pressed by the thrust button that descends through a handle operation to be brought into contact with the valve seat. When the handle is operated to move the thrust button upward, the pressure applied to the diagram by the thrust button is released, causing self-restoration of the diaphragm to its original shape so that the diaphragm is separated from the valve seat. The flow rate is regulated by operating the diaphragm as described above.

### CITATION LIST

### Patent Literature(s)

Patent Literature 1: JP H08-105554 A

### SUMMARY OF THE INVENTION

### Problem(s) to be Solved by the Invention

In the metal diaphragm valve described in Patent Literature 1, the diaphragm is configured to separate from the valve seat by self-restoration. It is thus difficult increase the flow rate by forcibly separating the diaphragm from the valve seat beyond the self-restoration of the diaphragm.

For example, the diaphragm may be welded to the thrust button or the like and the diaphragm may be forcibly separated from the valve seat by upward movement of the thrust button. However, in this case, a welding process is required to produce the metal diaphragm valve, making it difficult to reduce the production cost.

An object of the invention is to provide a diaphragm valve capable of increasing a flow rate by forcibly operating a diaphragm while reducing the production cost.

### Means for Solving the Problem(s)

A diaphragm valve according to an aspect of the invention includes: a body including a first channel, a second channel, and a valve seat; a cover screwed to be attached to the body; a rotatable valve shaft screwed to the cover in a manner movable up and down; a stem connected to the valve shaft and provided with a threaded shaft coaxial with the valve shaft; a holder screwed to the threaded shaft, the holder configured to come into contact with or separate from the valve seat to open or close the first channel and the second channel; and an annular diaphragm through which the threaded shaft penetrates, in which an outer peripheral portion of the diaphragm is mechanically clamped in a fixed manner between the body and the cover, and an inner peripheral portion of the diaphragm is mechanically clamped in a fixed manner between the stem and the holder.

In the diaphragm valve according to the aspect of the invention, the inner peripheral portion of the diaphragm is clamped in a fixed manner between the stem and the holder. This makes it possible to forcibly move up and down the diaphragm in accordance with the up-down movement of the valve shaft. In this configuration, in particular, the channels can be more widely opened beyond the self-restoration of the diaphragm to result in an increase in flow rate, as compared with, for example, a case where the flow rate is regulated through the self-restoration of the diaphragm as described above. Further, since both the outer peripheral portion and the inner peripheral portion of the diaphragm are mechanically clamped in a fixed manner, it is not necessary to weld the diaphragm to the stem or the like, reducing the production cost of the diaphragm valve.

In the diaphragm valve according to the aspect of the invention, the stem may include: a stem body provided with the threaded shaft and an abutment member configured to abut against the diaphragm and to receive the threaded shaft so that the threaded shaft is rotatable with respect to the stem body, and an outer diameter of the abutment member may be identical to an outer diameter of the stem body.

In such a configuration, when the holder is screwed to the threaded shaft of the stem body, the holder and the abutment member rotate together with the diaphragm to reduce friction caused between the diaphragm and the stem and between the diaphragm and the holder. Further, since the outer diameter of the abutment member is the same as the outer diameter of the stem body, the abutment area where the abutment member abuts against the diaphragm can be enlarged within a range in which the abutment member does not interfere with the cover and the like when the stem moves up and down together with the valve shaft. Accordingly, the diaphragm that receives the pressure of the fluid flowing within the body can be received by the wide abutment area of the abutment member.

In the diaphragm valve according to the aspect of the invention, the stem may include: a stem body provided with the threaded shaft and an abutment member configured to abut against the diaphragm and to receive the threaded shaft so that the threaded shaft is rotatable with respect to the stem body, the outer peripheral portion of the diaphragm may be fixedly clamped by the body and the cover so that the diaphragm extends obliquely upward toward the stem, and the abutment member may include a flat receiver surface configured to receive the diaphragm and a convex-curved surface continuous with an outer circumference of the receiver surface.

In such a configuration, when the stem descends to position the receiver surface of the abutment member below the fixedly clamped position of the outer peripheral portion of the diaphragm, a part of the diaphragm at the inner circumference side from a portion of the diaphragm at the outer circumference side at which the outer peripheral portion is fixedly clamped so that the diaphragm extends obliquely upward toward the stem, is curved obliquely downward toward the stem. In that configuration, the convex-curved surface provided for the abutment member restrains the stress from being locally concentrated on the diaphragm.

In the diaphragm valve according to the aspect of the invention, the stem may include: a stem body provided with the threaded shaft and an abutment member configured to abut against the diaphragm and to receive the threaded shaft so that the threaded shaft is rotatable with respect to the stem body, the holder may include a threaded hole to which the threaded shaft is screwed, the threaded hole opened in an upper surface of the holder, the abutment member may include a tapered surface slanted obliquely upward toward the threaded shaft, and a corner portion, at which the upper surface and the threaded hole of the holder meet, may define an acute angle and overlap with the tapered surface in up-down direction.

In such a configuration, the inner peripheral portion of the diaphragm can be fixedly tightly clamped, with the corner portion of the holder being wedged between the tapered surface of the abutment member and the threaded shaft. This makes it possible to further reduce fluid leakage or the like without welding.

Further, since the inner peripheral portion of the diaphragm is fixedly clamped as described above, the fixedly clamped part is slanted obliquely downward toward the outer circumference side. Thus, when the inner peripheral portion of the diaphragm descends, it is possible to inhibit noise caused by a vertical shape reversal of the diaphragm and to enhance the durability of the diaphragm.

In the diaphragm valve according to the aspect of the invention, an original shape of the diaphragm may be a flat annular disk, and the inner peripheral portion of the diaphragm may be positioned above or below the outer peripheral portion of the diaphragm in accordance with an up-down movement of the stem and the holder.

In such a configuration, the inner peripheral portion of the diaphragm whose original shape is a flat annular disk is forcibly positioned above or below the outer peripheral portion, making it possible to further inhibit noise as compared with a case using a diaphragm whose original shape is an upwardly bulging dome, for example.

According to the aspect of the invention, it is possible to provide a diaphragm valve capable of increasing a flow rate by forcibly operating a diaphragm while reducing the production cost.

### BRIEF DESCRIPTION OF DRAWINGS

FIG. 1 is a perspective view of a diaphragm valve according to an exemplary embodiment of the invention.

FIG. 2 is a vertical cross sectional view illustrating an opened state of the diaphragm valve according to the exemplary embodiment.

FIG. 3 is a vertical cross sectional view illustrating an intermediate state of the diaphragm valve according to the exemplary embodiment.

FIG. 4 is a vertical cross sectional view illustrating a closed state of the diaphragm valve according to the exemplary embodiment.

FIG. 5 is an enlarged schematic view illustrating a relevant part of the diaphragm valve in the opened state according to the exemplary embodiment.

FIG. 6 is an enlarged schematic view illustrating a relevant part of the diaphragm valve in the intermediate state according to the exemplary embodiment.

FIG. 7 is an enlarged schematic view illustrating a relevant part of the diaphragm valve in the closed state according to the exemplary embodiment.

### DESCRIPTION OF EMBODIMENT(S)

### Configuration of the Exemplary Embodiment

Referring to the drawings, an exemplary embodiment of the invention will be described below.

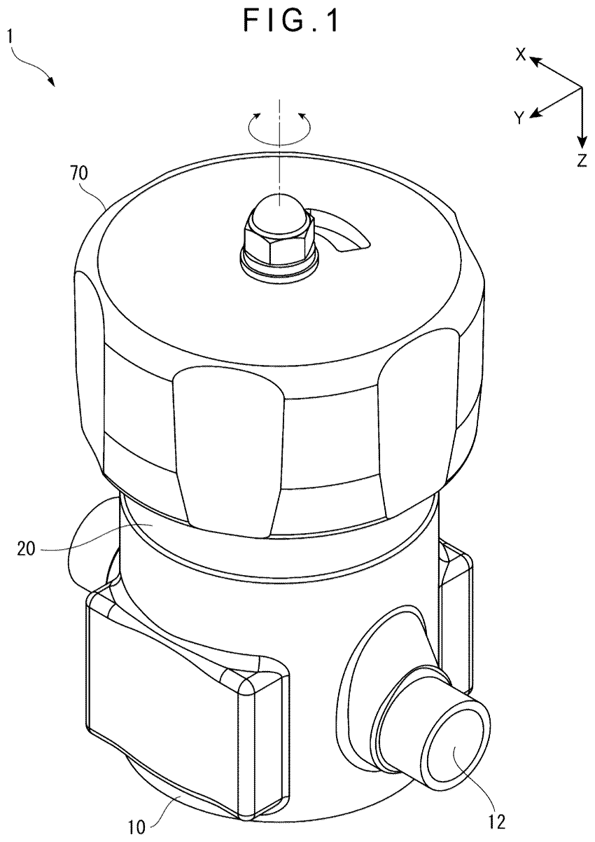

As illustrated in FIGS. 1 to 4, a diaphragm valve 1 according to the exemplary embodiment is a metal diaphragm valve configured to regulate a flow rate of a variety of fluids in semiconductor manufacturing equipment and the like, and is a large flow rate valve usable in a field requiring a high Cv value. The diaphragm valve 1, which is made of metal, includes a valve body 10 (body), a cover 20 screwed to be attached to the valve body 10, a valve shaft 30 screwed to the cover 20 in a manner movable up and down, a stem 40 connected to the valve shaft 30 and provided with a threaded shaft 42 coaxial with the valve shaft 30, a holder 50 screwed to the threaded shaft 42, and an annular diaphragm 60 through which the threaded shaft 42 penetrates. A handle 70 for rotating the valve shaft 30 is attached to the valve shaft 30.

In the description below, a right-left direction of the diaphragm valve 1 will be referred to as an X-axis direction, a front-rear direction of the diaphragm valve 1 will be referred to as a Y-axis direction, and an up-down direction of the diaphragm valve 1 will be referred to as a Z-axis direction. The X, Y, and Z-axis directions are orthogonal to each other. In the exemplary embodiment, the up, down, right, and left orientations of the diaphragm valve 1 are specified for the convenience of description. The up, down, right, and left orientations of the diaphragm valve 1, however, may depend on the actual installation.

The valve body 10 includes a first channel 11 provided near an inlet through which the fluid flows in, a second channel 12 provided near an outlet through which the fluid flows out, and a rise portion 13 that defines a cavity 131 through which the first channel 11 and the second channel 12 communicate with each other.

The first channel 11 is L-shaped in cross section in the exemplary embodiment. A first end located at a first side in the X-axis direction of the first channel 11 is opened at a position protruding from an outer circumferential surface 14 of the valve body 10. A second end located at a second side in the X-axis direction of the first channel 11 is opened substantially at the center of a bottom surface 132 that defines the cavity 131. A valve seat 15 slightly protruding upward from the bottom surface 132 is provided around the opening of the second end.

The second channel 12 is substantially doglegged in cross section in the exemplary embodiment. A first end located at the first side in the X-axis direction of the second channel 12 is opened over the bottom surface 132 and an inner circumferential surface 133 defining the cavity 131. The first end of the second channel 12 is positioned at the second side in the X-axis direction with respect to the second end of the first channel 11. A second end located at the second side in the X-axis direction of the second channel 12 is opened at a position protruding from the outer circumferential surface 14 of the valve body 10.

The rise portion 13 is in a form of a cylindrical portion rising from a periphery of the cavity 131 in the Z-axis direction. An upper portion 134 of the rise portion 13 is provided with an internal thread 135 to which the cover 20 is screwed. A lower portion 136 of the rise portion 13 is thickened inward relative to the upper portion 134. An annular step portion 137 is formed between the upper portion 134 and the lower portion 136 of the rise portion 13. The annular step portion 137 includes an annular groove that overlaps in the Z-axis direction with an annular projection 239 of a diaphragm retainer 235 described later.

The cover 20 is formed into a cylindrical shape, and includes an upper annular cover 21, a middle annular cover 22, and a lower annular cover 23 in an integrated fashion in the exemplary embodiment. The diaphragm retainer 235 is provided for the lower annular cover 23. In the cover 20, the outer diameter of the middle annular cover 22 is larger than that of the upper annular cover 21, the outer diameter of the lower annular cover 23 is larger than that of the middle annular cover 22, and the inner diameter of the lower annular cover 23 is larger than those of the upper annular cover 21 and the middle annular cover 22.

An indicator 71 is fitted to an outer circumferential portion 211 of the upper annular cover 21 in a rotatable guiding manner around an axis along the Z-axis direction. An inner circumferential portion of the upper annular cover 21 is defined as an internal thread 212 to which the valve shaft 30 is screwed. The indicator 71 is configured so that “OPEN” and “CLOSE” are displayed on an upper surface thereof, and that display can be seen through a hole 72 formed in the handle 70. The recession/projection of the indicator 71 is fitted to the handle 70 at predetermined positions in its rotation direction, and the indicator 71 in this fitting state rotates together with the handle 70.

An inner circumferential portion 222 of the middle annular cover 22 is in slidable contact with the valve shaft 30 so that the valve shaft 30 is movable up and down in the Z-axis direction.

An outer circumferential portion of the lower annular cover 23 is defined as an external thread 231 screwed to the upper portion 134 of the rise portion 13. An inner diameter of an inner circumferential portion 232 of the lower annular cover 23 is larger than an outer diameter of the stem 40. The diaphragm retainer 235 is provided for the lower annular cover 23.

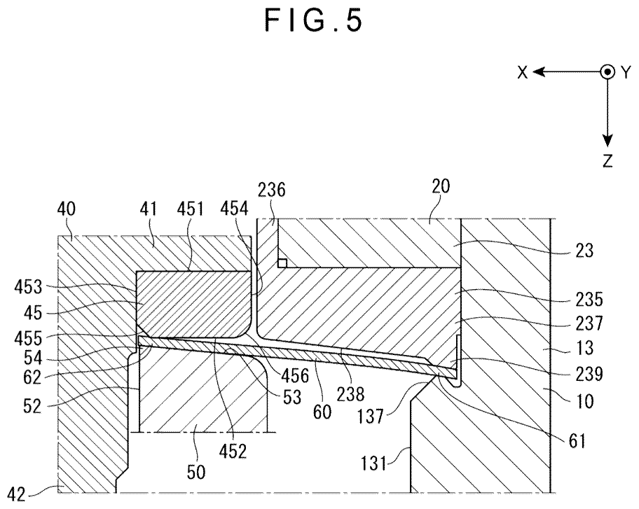

The diaphragm retainer 235 includes a cylindrical portion 236 disposed between the inner circumferential portion 232 and the stem 40 and a retainer 237 that is in a form of an annular disk extending from a lower end of the cylindrical portion 236 toward the outer circumference side. A lower surface 238 (see FIG. 5) of the retainer 237 is slanted obliquely upward from the outer circumference side toward the inner circumference side (i.e. toward the stem 40). A lower part of the outer periphery of the diaphragm retainer 235 is provided with an annular projection 239 protruding downward. An outer peripheral portion 61 of the diaphragm 60 is mechanically clamped in a fixed manner (screw fixing in the exemplary embodiment) between the annular projection 239 and the annular step portion 137 of the rise portion 13 by screwing the external thread 231 of the lower annular cover 23 to the internal thread 135 of the valve body 10. The outer peripheral portion 61 of the diaphragm 60 is held between the annular projection 239 of the diaphragm retainer 235 provided for the cover 20 and the annular step portion 137 with the annular projection 239 overlapping with the groove in the annular step portion 137 of the valve body 10 in the Z-axis direction. Thus, the outer peripheral portion 61 of the diaphragm 60 is fixedly clamped by the valve body 10 and the cover 20 so that the diaphragm 60 extends obliquely upward toward the stem 40. The outer peripheral portion 61 of the diaphragm 60 is welded neither to the annular projection 239 nor to the annular step portion 137.

The valve shaft 30 extends in the Z-axis direction. The valve shaft 30 includes: an upper valve-shaft part 31 having an external thread 311 on an outer circumferential portion thereof, the external thread 311 being screwed to the internal thread 212 of the upper annular cover 21; and a lower valve-shaft part 32 whose outer circumferential portion is in slidable contact with the inner circumferential portion 222 of the middle annular cover 22 in a manner movable up and down. In the exemplary embodiment, a single O ring is fitted on the outer circumferential portion of the lower valve-shaft part 32. The handle 70 is attached to an upper end 33 of the valve shaft 30, and the stem 40 is attached to a lower end 34 of the valve shaft 30.

The stem 40 includes: a stem body 41 provided with the threaded shaft 42 and a recess 43; and an abutment member (piece) 45 that abuts against the diaphragm 60 and receives the threaded shaft 42 so that the threaded shaft 42 is rotatable with respect to the stem body 41.

The stem body 41 is in a form of a short cylinder except for the threaded shaft 42 and the recess 43. The threaded shaft 42 extends from a lower surface of the short cylinder. An external thread is formed in the outer circumferential surface of the threaded shaft 42. The threaded shaft 42 is positioned to be coaxial with a rotation axis of the valve shaft 30 along the Z-axis direction. The recess 43 is opened in an upper surface of the above-described short cylinder, and the bottom end 34 of the valve shaft 30 is rotatably fitted thereto. The outer diameter of the stem body 41 is larger than the outer diameter of the valve shaft 30.

The abutment member 45 is formed from a metal annular plate. As illustrated in FIG. 5, the abutment member 45 includes an upper surface 451, a lower surface 452, an inner circumferential surface 453, and an outer circumferential surface 454. The lower surface 452 is configured as a planar receiver surface that receives the diaphragm 60. As illustrated in FIGS. 5 to 7, the abutment member 45 includes a tapered surface 455, which is continuous with the lower surface 452 and the inner circumferential surface 453 and is slanted obliquely upward toward the threaded shaft 42. In addition, the abutment member 45 includes a convex-curved surface 456, which is continuous with the lower surface 452 (outer circumference of the receiver surface) and the outer circumferential surface 454 and is convex-curved toward the outer circumference side. The outer diameter of the abutment member 45 is the same as the outer diameter of the stem body 41.

A seal ring 51 is attached to the holder 50 so that the seal ring 51 can abut against the valve seat 15. In addition, the holder 50 has a threaded hole 52 of which inner circumferential surface is provided with an internal thread screwed to the external thread of the threaded shaft 42. The threaded hole 52 is opened in an upper surface 53 of the holder 50. The upper surface 53 of the holder 50 is slanted obliquely downward from a threaded shaft 42 side (i.e. the inner circumference side) toward a rise portion 13 side (i.e. the outer circumference side), so that the upper surface 53 follows the shape of the diaphragm 60 when the valve shaft 30 is moved upward. The corner portion 54, at which the upper surface 53 meets the threaded hole 52, defines an acute angle smaller than 90 degrees and overlaps with the tapered surface 455 in the Z-axis direction. An inner peripheral portion 62 of the diaphragm 60 is pushed upward at and near the corner portion 54 to abut against the abutment member 45 at a position closer to the outer circumference than the corner portion 54. Thus, the inner peripheral portion 62 of the diaphragm 60 is mechanically clamped in a fixed manner (screw fixing in the exemplary embodiment) so that the diaphragm 60 is slanted obliquely downward toward the outer circumference side. The outer peripheral portion 62 of the diaphragm 60 is welded neither to the annular stem 40 nor to the holder 50.

The diaphragm 60 is made of metal, and an original shape of the diaphragm 60 is a flat annular disk. The diaphragm 60 is deformable in the Z-axis direction. The outer peripheral portion 61 of the diaphragm 60 is mechanically clamped in a fixed manner between the valve body 10 and the cover 20 without welding so that the diaphragm 60 extends obliquely upward toward the stem 40, by screwing and attaching the cover 20 to the valve body 10. The inner peripheral portion 62 of the diaphragm 60 is mechanically clamped in a fixed manner between the stem 40 and the holder 50 without welding so that the diaphragm 60 is slanted obliquely downward toward the outer circumference side, by screwing and attaching the holder 50 to the stem 40. The force for clamping the outer peripheral portion 61 and the inner peripheral portion 62 of the diaphragm 60 is appropriately determined depending on the size so as not to cause leakage of the fluid and not to excessively compress the diaphragm. The diaphragm 60 defines a space of the cavity 131.

An opening and closing operation of the diaphragm valve 1 will be described below.

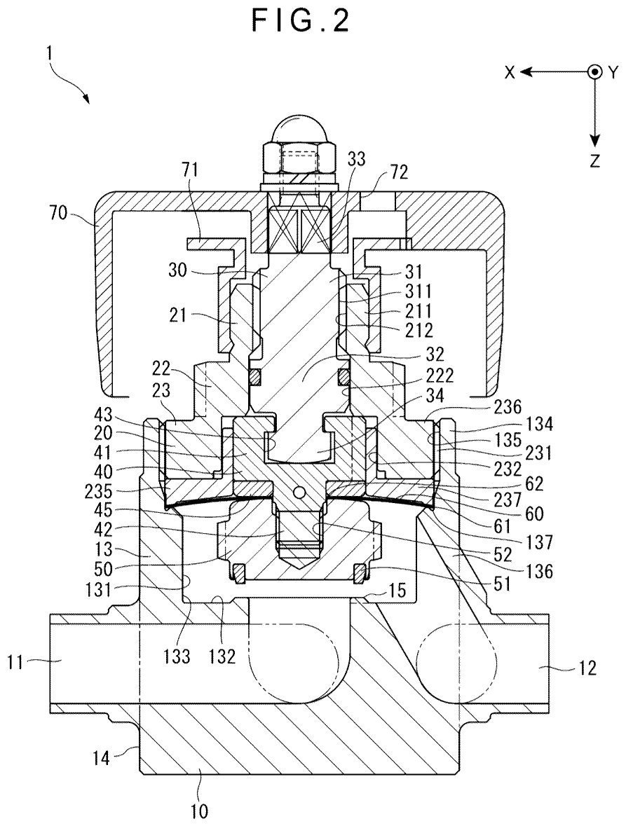

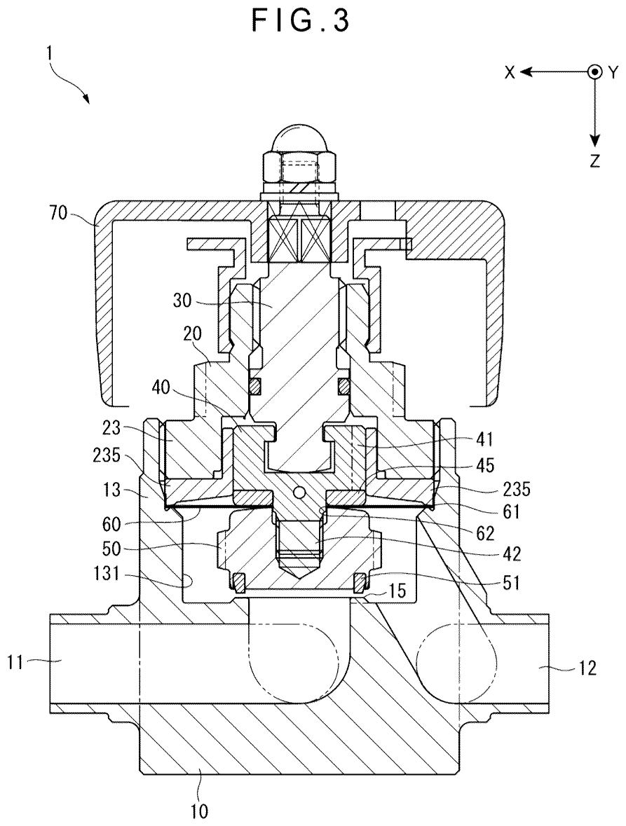

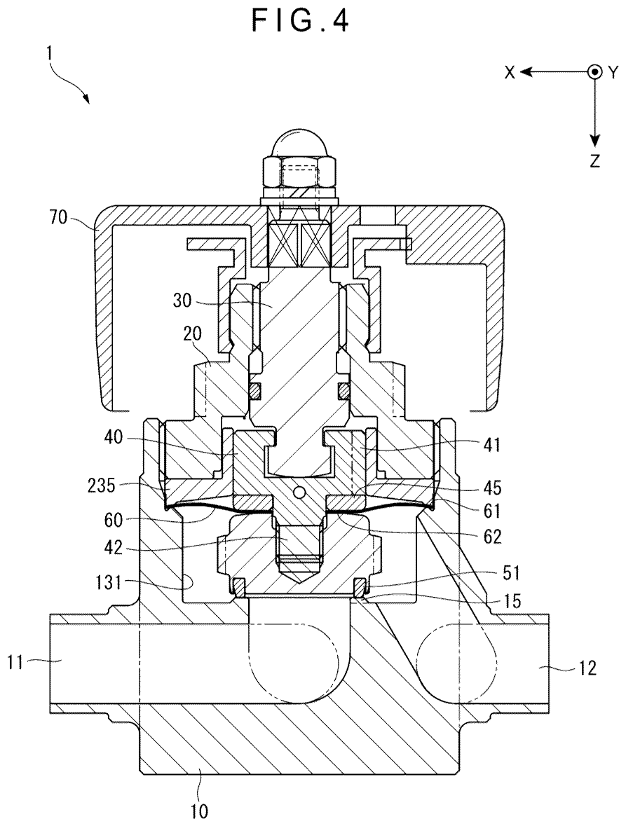

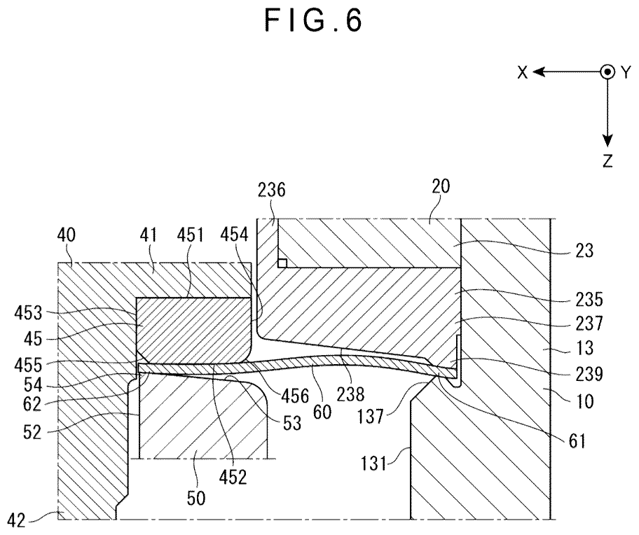

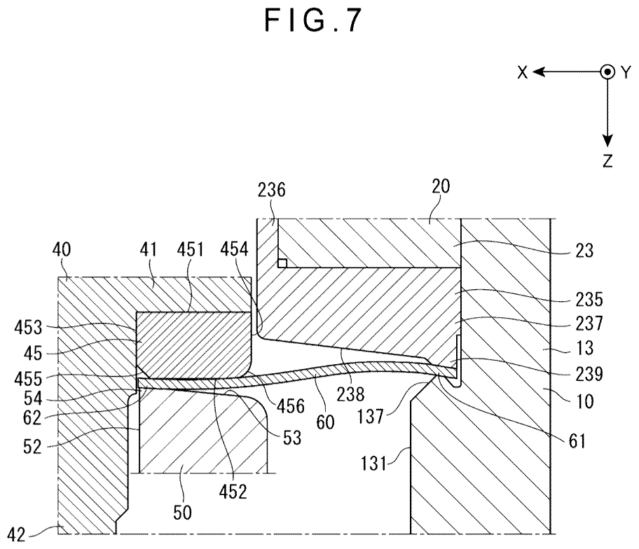

FIGS. 2 and 5 each illustrate an opened state of the diaphragm valve 1, FIGS. 3 and 6 each illustrate an intermediate state of the diaphragm valve 1, and FIGS. 4 and 7 each illustrate a closed state of the diaphragm valve 1. In the opened state, the seal ring 51 of the holder 50 is positioned above and away from the valve seat 15 of the valve body 10 where the first channel 11 and the second channel 12 communicate with each other through the space of the cavity 131. In the intermediate state, the holder 50 is positioned closer to the valve seat 15 than in the opened state, thus narrowing the path for communication between the first channel 11 and the second channel 12 in the space of the cavity 131. In the closed state, the seal ring 51 of the holder 50 is in contact with the valve seat 15, thus blocking the fluid flow between the first channel 11 and the second channel 12.

### Closing Operation

First, in a state where the diaphragm valve 1 is in the opened state illustrated in FIGS. 2 and 5, the handle 70 is rotated around the axis of the valve shaft 30 to rotate the valve shaft 30. When the valve shaft 30 descends in accordance with the rotation, the stem 40 and the holder 50 descend without being rotated, causing the abutment member 45 of the stem 40 to push the inner peripheral portion 62 of the diaphragm 60 downward. The diaphragm valve 1 thus has the closed state as illustrated in FIGS. 4 and 7 after the intermediate state illustrated in FIGS. 3 and 6. In the intermediate state illustrated in FIG. 6, the inner peripheral portion 62 is positioned substantially at the same height (up-down position) as the outer peripheral portion 61. In the closed state illustrated in FIG. 7, the inner peripheral portion 62 is positioned below the outer peripheral portion 61. Assuming that the position of the inner peripheral portion 62 in the intermediate state is a reference position, the position of the inner peripheral portion 62 is lower than the reference position by less than 1 mm in the closed state. In the intermediate state and the closed state, the abutment member 45 is positioned to protrude downward beyond the inner circumferential portion of the retainer 237 of the diaphragm retainer 235. In the intermediate state illustrated in FIG. 6 and the closed state illustrated in FIG. 7, the lower surface 452 of the abutment member 45 receives the inner peripheral portion 62 of the diaphragm 60 at the upper side, and the convex-curved surface 456 may abut against the diaphragm 60 so that stress is not concentrated on the diaphragm 60. In the diaphragm 60, the outer peripheral portion 61 and inner peripheral portion 62 are fixedly clamped in a specific manner as described above. Thus, in the intermediate state and closed state, the outer peripheral portion 61 is slanted obliquely upward toward the inner circumference side, an intermediate part closer to the inner peripheral portion 62 than to the outer peripheral portion 61 is slanted obliquely downward toward the inner circumference side, and the inner peripheral portion 62 at the inner circumference side from the intermediate part is slanted more gently than the intermediate part. The diaphragm 60 is thus forcibly curved into a specific shape. This inhibits noise (e.g. clicking sound) in the diaphragm 60 when the diaphragm valve 1 is operated to the opened state or the closed state. Further, since the corner portion 54 overlaps with the tapered surface 455 in the Z-axis direction, even without being welded, the inner peripheral portion 62 of the diaphragm 60 can be fixedly tightly clamped by the abutment member 45 and the inner circumferential portion of the holder 50. In the exemplary embodiment, the forced deformation of the diaphragm 60 caused by the rotation of the handle 70 when closing the channels occurs within a range in which the diaphragm 60 can be elastically deformed without plastically deformed. With the deformation of the diaphragm 60 within the above range, the diaphragm 60 is inhibited from being plastically deformed to reduce its durability, for example.

As described above, the diaphragm valve 1 closes the first channel 11 and the second channel 12 as the holder 50 is brought into contact with the valve seat 15.

### Opening Operation

First, in a state where the diaphragm valve 1 is in the closed state illustrated in FIGS. 4 and 7, the handle 70 is reversely rotated around the axis of the valve shaft 30 to reversely rotate the valve shaft 30. When the valve shaft 30 ascends in accordance with the rotation, the stem 40 and the holder 50 ascend without being rotated, causing the holder 50 to push the inner peripheral portion 62 of the diaphragm 60 upward. The diaphragm valve 1 thus has the intermediate state as illustrated in FIGS. 3 and 6, and then has the opened state as illustrated in FIGS. 2 and 5 by forcibly pushing the diaphragm 60 upward beyond its self-restoration. In the opened state, the diaphragm 60 is farther separated away from the valve seat 15 than a case where the diaphragm 60 is self-restored upward, enlarging the communication space between the first channel 11 and the second channel 12, which results in a further increase in flow rate. In the exemplary embodiment, the forced deformation of the diaphragm 60 caused by the rotation of the handle 70 when opening the channels occurs within a range in which the diaphragm 60 can be elastically deformed without plastically deformed. With the deformation of the diaphragm 60 within the above range, the diaphragm 60 is inhibited from being plastically deformed to reduce its durability, for example. In the opened state illustrated in FIG. 5, the inner peripheral portion 62 is positioned above the outer peripheral portion 61. Further, in the opened state, the lower surface 452 of the abutment member 45 is positioned substantially at the same level in the up-down direction as the inner circumferential portion of the retainer 237 of the diaphragm retainer 235. The upper surface 53 of the holder 50 receives the inner peripheral portion 62 of the diaphragm 60 at the lower side. In the opened state, the diaphragm 60 has a substantially dome shape such that the diaphragm 60 is slanted obliquely upward from the outer peripheral portion 61 to the inner peripheral portion 62. Assuming that the position of the inner peripheral portion 62 in the intermediate state is the reference position, the position of the inner peripheral portion 62 is upper than the reference position by 1 to 2 mm in the opened state.

As described above, the diaphragm valve 1 establishes the communication between the first channel 11 and the second channel 12 as the holder 50 is separated from the valve seat 15.

As described above with reference to the diaphragm valve 1 of the exemplary embodiment, the inventor has invented the diaphragm valve 1 for a large flow rate with a large stroke in which the diaphragm 60 is fixed to the stem 40, the diaphragm valve 1 having excellent stroke, sealability, and durability by mechanically fixing the diaphragm 60 instead of welding the diaphragm 60 to the stem 40 and designing the shape of the components mechanically holding the diaphragm 60 through stress analysis.

### Effect of the Exemplary Embodiment

In the diaphragm valve 1 of the exemplary embodiment, in particular, the outer peripheral portion 61 of the diaphragm 60 is mechanically clamped in a fixed manner between the valve body 10 and the cover 20, and the inner peripheral portion 62 of the diaphragm 60 is mechanically clamped in a fixed manner between the stem 40 and the holder 50. This makes it possible to forcibly move up and down the diaphragm 60 in accordance with the up-down movement of the valve shaft 30. In this configuration, the channels can be more widely opened beyond the self-restoration of the diaphragm 60 to result in a further increase in flow rate, as compared with, for example, a case where the flow rate is regulated through the self-restoration of the diaphragm as described above. Further, since both the outer peripheral portion 61 and the inner peripheral portion 62 of the diaphragm 60 are mechanically clamped in a fixed manner, it is not necessary to weld the diaphragm 60 to the stem 40 or the like, reducing the production cost of the diaphragm valve 1.

In the exemplary embodiment, in particular, the outer diameter of the abutment member 45 is the same as the outer diameter of the stem body 41. Thus, when the holder 50 is screwed to the threaded shaft 42 of the stem body 41, the holder 50 and the abutment member 45 rotate together with the diaphragm 60 to reduce friction caused between the diaphragm 60 and the stem 40 and between the diaphragm 60 and the holder 50. Further, since the outer diameter of the abutment member 45 is the same as the outer diameter of the stem body 41, the abutment area where the abutment member 45 abuts against the diaphragm 60 can be enlarged within a range in which the abutment member 45 does not interfere with the cover 20 and the like when the stem 40 moves up and down together with the valve shaft 30. Accordingly, the diaphragm 60 that receives the pressure of the fluid flowing within the valve body 10 can be received by the above-described wide abutment area of the abutment member 45.

In the exemplary embodiment, in particular, the outer peripheral portion 61 of the diaphragm 60 is fixedly clamped by the valve body 10 and the cover 20 so that the diaphragm 60 extends obliquely upward toward the stem 40, and the abutment member 45 includes the lower surface 452 (flat receiver surface) that receives the diaphragm 60 and the convex-curved surface 456 continuous with the outer circumference of the lower surface 452. Thus, when the stem 40 descends to position the lower surface 452 of the abutment member 45 below the fixedly clamped position of the outer peripheral portion 61 of the diaphragm 60, a part of the diaphragm 60 at the inner circumference side from a portion of the diaphragm 60 at the outer circumference side at which the outer peripheral portion 61 is fixedly clamped so that the diaphragm 60 extends obliquely upward toward the stem 40, is curved obliquely downward toward the stem 40. In that configuration, the convex-curved surface 456 provided for the abutment member 45 restrains the stress from being locally concentrated on the diaphragm 60.

In the exemplary embodiment, in particular, the abutment member 45 includes the tapered surface 455 slanted obliquely upward toward the threaded shaft 42, and the corner portion 54 at which the upper surface 53 and the threaded hole 52 of the holder 50 meet is designed to define an acute angle and overlap with the tapered surface 455 in the Z-axis direction. Thus, the inner peripheral portion 62 of the diaphragm 60 can be fixedly tightly clamped, with the corner portion 54 of the holder 50 being wedged between the tapered surface 455 of the abutment member 45 and the threaded shaft 42. This makes it possible to further reduce fluid leakage or the like without welding for the inner peripheral portion 62. Further, since the inner peripheral portion 62 of the diaphragm 60 is fixedly clamped as described above, the fixedly clamped part is slanted obliquely downward toward the outer circumference side. Thus, when the inner peripheral portion 62 of the diaphragm 60 descends, it is possible to inhibit noise caused by a vertical shape reversal of the diaphragm 60 and to enhance the durability of the diaphragm 60.

In the exemplary embodiment, the original shape of the diaphragm 60 is a flat annular disk, and the inner peripheral portion 62 of the diaphragm 60 is positioned above or below the outer peripheral portion 61 of the diaphragm 60 in accordance with the up-down movement of the stem 40 and the holder 50. In other words, the inner peripheral portion 62 of the diaphragm 60 whose original shape is a flat annular disk is forcibly positioned above or below the outer peripheral portion 61, making it possible to further inhibit noise as compared with a case using a diaphragm whose original shape is an upwardly bulging dome, for example.

### Modifications

In the above exemplary embodiment, the outer diameter of the abutment member 45 is the same as the outer diameter of the stem body 41. The invention, however, is not limited thereto. For example, the outer diameter of the abutment member 45 may be smaller than the outer diameter of the stem body 41, or may be larger than the outer diameter of the stem body 41 as long as the abutment member 45 does not interfere with the up-down movement of the stem body 41.

In the above exemplary embodiment, the outer diameter of the holder 50 is larger than the outer diameter of the stem 40. The invention, however, is not limited thereto. The outer diameter of the holder 50 may be equal to or less than the outer diameter of the stem 40.

In the stem 40 of the above exemplary embodiment, the abutment member 45 is rotatable with respect to the stem body 41, and the abutment member 45 rotates together with the diaphragm 60 to restrain the friction against the diaphragm 60 when the holder 50 is screwed to the threaded shaft 42. The invention, however, is not limited thereto, and if the diaphragm valve 1 can be configured without considering the above advantage, the abutment member 45 may be integrated with the stem body 41. In this configuration, the stem 40 formed integrally with the abutment member 45 has a (non-rotatable) portion corresponding to the abutment member 45.

In the above exemplary embodiment, the inner peripheral portion 62 of the diaphragm 60 is fixedly tightly clamped by the tapered surface 455 of the abutment member 45 and the acute corner portion 54 of the holder 50. The invention, however, is not limited thereto. If the tapered surface 455 and the acute corner portion 54 are not necessary for the fixedly clamping for the inner peripheral portion 62 of the diaphragm 60 without welding, such configurations may not be provided.

In the above exemplary embodiment, the outer peripheral portion 61 of the diaphragm 60 is fixedly clamped by the valve body 10 and the cover 20 so that the diaphragm 60 extends obliquely upward toward the stem 40. This restrains noise that may be caused by a vertical shape reversal of the diaphragm 60 even when the inner peripheral portion 62 of the diaphragm 60 is positioned below the outer peripheral portion 61. The invention, however, is not limited thereto. If it is not necessary to restrain such noise, it is not indispensable to fixedly clamp the outer peripheral portion 61 of the diaphragm 60 by the valve body 10 and the cover 20 in the above-described direction. The diaphragm 60 may be horizontally clamped in a fixed manner, for example.

In the above exemplary embodiment, the convex-curved surface 456 is provided for the abutment member 45. The invention, however, is not limited thereto. The convex-curved surface 456 may not be provided if the diaphragm 60 can operate properly without the convex-curved surface 456.

In the above exemplary embodiment, the diaphragm valve 1 is described as a metal diaphragm valve for a large flow rate usable for semiconductor manufacturing equipment and the like. The invention, however, is not limited thereto, and the diaphragm valve 1 is also applicable in the liquid crystal market, for example.

### EXPLANATION OF CODES

1 . . . diaphragm valve, 10 . . . valve body (body), 11 . . . first channel, 12 . . . second channel, 13 . . . rise portion, 131 . . . cavity, 132 . . . bottom surface, 133, 453 . . . inner circumferential surface, 134 . . . upper portion, 135, 212 . . . internal thread, 136 . . . lower portion, 137 . . . annular step portion, 14 . . . outer circumferential surface, 15 . . . valve seat, 20 . . . cover, 21 . . . upper annular cover, 211 . . . outer circumferential portion, 22 . . . middle annular cover, 222, 232 . . . inner circumferential portion, 23 . . . lower annular cover, 231, 311 . . . external thread, 235 . . . diaphragm retainer, 236 . . . cylindrical portion, 237 . . . retainer, 238, 452 . . . lower surface, 239 . . . annular projection, 30 . . . valve shaft, 31 . . . upper valve-shaft part, 32 . . . lower valve-shaft part, 33 . . . upper end, 34 . . . lower end, 40 . . . stem, 41 . . . stem body, 42 . . . threaded shaft, 43 . . . recess, 45 . . . abutment member, 451, 53 . . . upper surface, 454 . . . outer circumferential surface, 455 . . . tapered surface, 456 . . . convex-curved surface, 50 . . . holder, 51 . . . seal ring, 52 . . . threaded hole, 54 . . . corner portion, 60 . . . diaphragm, 61 . . . outer peripheral portion, 62 . . . inner peripheral portion, 70 . . . handle, 71 . . . indicator, 72 . . . hole.

1. A diaphragm valve comprising:
a body comprising a first channel, a second channel, and a valve seat;
a cover screwed to be attached to the body;
a rotatable valve shaft screwed to the cover and configured to be movable up and down by rotating;
a stem connected to the valve shaft and provided with a threaded shaft coaxial with the valve shaft;
a holder screwed to the threaded shaft, the holder configured to selectably contact and separate from the valve seat to selectably open and close the first channel and the second channel; and
an annular diaphragm through which the threaded shaft penetrates, wherein
an outer peripheral portion of the diaphragm is mechanically clamped in a fixed manner between the body and the cover, and
an inner peripheral portion of the diaphragm is mechanically clamped in a fixed manner between the stem and the holder.

2. The diaphragm valve according to claim 1, wherein
the stem includes: a stem body provided with the threaded shaft and an abutment member configured to abut against the diaphragm and to receive the threaded shaft so that the threaded shaft is rotatable with respect to the stem body, and
an outer diameter of the abutment member is identical to an outer diameter of the stem body.

3. The diaphragm valve according to claim 1, wherein
the stem includes: a stem body provided with the threaded shaft and an abutment member configured to abut against the diaphragm and to receive the threaded shaft so that the threaded shaft is rotatable with respect to the stem body,
the outer peripheral portion of the diaphragm is fixedly clamped by the body and the cover so that the diaphragm extends obliquely upward toward the stem, and
the abutment member includes a flat receiver surface configured to receive the diaphragm and a convex-curved surface continuous with an outer circumference of the receiver surface.

4. The diaphragm valve according to claim 1, wherein
the stem includes: a stem body provided with the threaded shaft and an abutment member configured to abut against the diaphragm and to receive the threaded shaft so that the threaded shaft is rotatable with respect to the stem body,
the holder includes a threaded hole to which the threaded shaft is screwed, the threaded hole opened in an upper surface of the holder,
the abutment member includes a tapered surface slanted obliquely upward toward the threaded shaft, and
a corner portion, at which the upper surface and the threaded hole of the holder meet, defines an acute angle and overlaps with the tapered surface in up-down direction.

5. The diaphragm valve according to claim 4, wherein
an original shape of the diaphragm is a flat annular disk, and
the inner peripheral portion of the diaphragm is positioned above or below the outer peripheral portion of the diaphragm in accordance with an up-down movement of the stem and the holder.

6. The diaphragm valve according to claim 2, wherein
the stem includes: a stem body provided with the threaded shaft and an abutment member configured to abut against the diaphragm and to receive the threaded shaft so that the threaded shaft is rotatable with respect to the stem body,
the outer peripheral portion of the diaphragm is fixedly clamped by the body and the cover so that the diaphragm extends obliquely upward toward the stem, and
the abutment member includes a flat receiver surface configured to receive the diaphragm and a convex-curved surface continuous with an outer circumference of the receiver surface.

7. The diaphragm valve according to claim 2, wherein
the stem includes: a stem body provided with the threaded shaft and an abutment member configured to abut against the diaphragm and to receive the threaded shaft so that the threaded shaft is rotatable with respect to the stem body,
the holder includes a threaded hole to which the threaded shaft is screwed, the threaded hole opened in an upper surface of the holder,
the abutment member includes a tapered surface slanted obliquely upward toward the threaded shaft, and
a corner portion, at which the upper surface and the threaded hole of the holder meet, defines an acute angle and overlaps with the tapered surface in up-down direction.

8. The diaphragm valve according to claim 7, wherein
an original shape of the diaphragm is a flat annular disk, and
the inner peripheral portion of the diaphragm is positioned above or below the outer peripheral portion of the diaphragm in accordance with an up-down movement of the stem and the holder.

9. The diaphragm valve according to claim 3, wherein
the stem includes: a stem body provided with the threaded shaft and an abutment member configured to abut against the diaphragm and to receive the threaded shaft so that the threaded shaft is rotatable with respect to the stem body,
the holder includes a threaded hole to which the threaded shaft is screwed, the threaded hole opened in an upper surface of the holder,
the abutment member includes a tapered surface slanted obliquely upward toward the threaded shaft, and
a corner portion, at which the upper surface and the threaded hole of the holder meet, defines an acute angle and overlaps with the tapered surface in up-down direction.

10. The diaphragm valve according to claim 9, wherein
an original shape of the diaphragm is a flat annular disk, and
the inner peripheral portion of the diaphragm is positioned above or below the outer peripheral portion of the diaphragm in accordance with an up-down movement of the stem and the holder.

11. The diaphragm valve according to claim 6, wherein
the stem includes: a stem body provided with the threaded shaft and an abutment member configured to abut against the diaphragm and to receive the threaded shaft so that the threaded shaft is rotatable with respect to the stem body,
the holder includes a threaded hole to which the threaded shaft is screwed, the threaded hole opened in an upper surface of the holder,
the abutment member includes a tapered surface slanted obliquely upward toward the threaded shaft, and
a corner portion, at which the upper surface and the threaded hole of the holder meet, defines an acute angle and overlaps with the tapered surface in up-down direction.

12. The diaphragm valve according to claim 11, wherein
an original shape of the diaphragm is a flat annular disk, and
the inner peripheral portion of the diaphragm is positioned above or below the outer peripheral portion of the diaphragm in accordance with an up-down movement of the stem and the holder.
